(19) United States
(12) Patent Application Publication
(10) Pub. No.: US 2025/0225364 A1
(43) Pub. Date: Jul. 10, 2025

(54) METHOD, SYSTEM AND COMPUTER-READABLE STORAGE MEDIUM FOR IMPLEMENTING CARBON TRACKING AND ANALYSIS IN CITY

(71) Applicant: BCEG Environmental Remediation Co.,Ltd., Beijing (CN)

(72) Inventors: Bo YUAN, Beijing (CN); Hongwei XU, Beijing (CN); Ting QU, Beijing (CN); Yaru LIU, Beijing (CN); Xinjiang CONG, Beijing (CN); Yaxiu LI, Beijing (CN); Simin WANG, Beijing (CN); Shupeng LI, Beijing (CN); Lili GUO, Beijing (CN)

(21) Appl. No.: 19/090,626

(22) Filed: Mar. 26, 2025

Related U.S. Application Data
(63) Continuation of application No. PCT/CN2024/140268, filed on Dec. 18, 2024.

(30) Foreign Application Priority Data
Dec. 21, 2023 (CN) 202311763901.1

(51) Int. Cl. G06N 3/006; G06Q 10/047; G06Q 10/067

(52) U.S. Cl. CPC G06N 3/006; G06Q 10/047; G06Q 10/067

(57) ABSTRACT

A method for carbon tracking and analysis in a city is provided. Basic information of a target city is acquired. A three-dimensional visual city model is constructed based on the basic information. The target city is divided into a plurality of sub-regions. A carbon emission monitoring plan is formulated based on regional properties of each sub-region. According to the acquired carbon emission monitoring data, a carbon emission change of each sub-region within the current preset period is analyzed by means of linear regression to obtain carbon emission change trend data of each sub-region. Carbon emission tracking is performed based on the carbon emission change trend data. A current carbon tracking route and a carbon prediction route are generated by means of a preset ant colony optimization algorithm. A system non-transitory computer-readable storage medium for implementing carbon tracking and analysis in a city and are also provided.

### CROSS-REFERENCE TO RELATED APPLICATIONS

This application is a continuation of International Patent Application No. PCT/CN2024/140268, filed on Dec. 18, 2024, which claims the benefit of priority from Chinese Patent Application No. 202311763901.1, filed on Dec. 21, 2023. The content of the aforementioned application, including any intervening amendments made thereto, is incorporated herein by reference in its entirety.

### TECHNICAL FIELD

This application relates to carbon pollution analysis, and more particularly to a method, system and computer-readable storage medium for implementing carbon tracking and analysis in a city.

### BACKGROUND

With the acceleration of urbanization and the continuous development of industrial production, carbon emissions in cities have been increasing. Carbon pollution has an increasingly significant impact on cities, not only affecting the health and quality of life of city residents, but also posing a great threat to the sustainable development of cities.

However, limited by traditional technology, the existing technology for carbon emission analysis and pollution prediction in cities is relatively weak, which is not conducive to accurate carbon emission analysis and prediction in certain areas of the city, making it difficult to achieve accurate carbon tracking and scientific carbon monitoring in cities.

### SUMMARY

An object of the disclosure is to provide method, system and computer-readable storage medium for implementing carbon tracking and analysis in a city, so as to overcome the deficiencies in the prior art.

In order to achieve the above object, the following technical solutions are adopted.

In a first aspect, this application provides a method for carbon tracking and analysis in a city, comprising:
(1) acquiring basic information of a target city, and constructing a city model based on the basic information; wherein the city model is three-dimensional visual;
(2) dividing, based on regional information of the target city and the city model, the target city into a plurality of sub-regions;
(3) formulating a carbon emission monitoring plan based on regional properties of each of the plurality of sub-regions; performing carbon emission monitoring on each of the plurality of sub-regions based on the carbon emission monitoring plan; and acquiring carbon emission monitoring data of the target city within a current preset period;
(4) according to the carbon emission monitoring data, analyzing a carbon emission change of each of the plurality of sub-regions within the current preset period by means of linear regression, so as to obtain carbon emission change trend data of each of the plurality of sub-regions;
(5) performing carbon emission tracking based on the carbon emission change trend data; and generating a current carbon tracking route and a carbon prediction route by means of a preset ant colony optimization algorithm; and
(6) generating a monitoring correction plan based on the current carbon tracking route and the carbon prediction route.

In some embodiments, in step (1), the basic information comprises city map outline information, city area information and city region information; and the city region information comprises industrial region distribution information, agricultural region distribution information and residential region distribution information; and
the city model is constructed through steps of:
constructing the city model according to the city map outline information and the city area information; and
importing the city region information into the city model, such that the city model is divided into an industrial region, an agricultural region and a residential region.

In some embodiments, step (2) is performed through a step of:
dividing the industrial region into industrial sub-regions according to an industrial distribution density, dividing the agricultural region into agricultural sub-regions according to an agricultural distribution density, and dividing the residential region into residential sub-regions according to a residential distribution density, such that the target city is divided into N sub-regions comprising the industrial sub-regions, the agricultural sub-regions and the residential sub-regions;
wherein an area and a shape of each of the N sub-regions are respectively within a preset range.

In some embodiments, in step (3), the carbon emission monitoring plan is formulated through steps of:
based on the city region information and the city model, performing distribution density analysis on each of the industrial region, the agricultural region and the residential region to obtain industrial distribution density information, agricultural distribution density information and residential distribution density information; and
based on the industrial distribution density information, the agricultural distribution density information, the residential distribution density information and the city model, performing a first analysis of a carbon pollution monitoring point number and carbon pollution monitoring point distribution of each of the N sub-regions to obtain the carbon emission monitoring plan; and
the carbon emission monitoring data comprises N sets of sub-region monitoring data.

In some embodiments, step (4) is performed through steps of:
(4.1) setting a single sub-region among the N sub-regions as an analysis unit; acquiring a set of sub-region monitoring data corresponding to the single sub-region from the carbon emission monitoring data;
(4.2) performing carbon emission linear change analysis on the set of sub-region monitoring data corresponding to the single sub-region to obtain a first carbon emission change curve of the single sub-region within the current preset period;
(4.3) according to the first carbon emission change curve of the single sub-region, performing data prediction by means of linear regression prediction, so as to obtain a next-period prediction curve as a second carbon emission change curve of the single sub-region; and
(4.4) repeating steps (4.1)-(4.3) to obtain a first carbon emission change curve and a second carbon emission change curve of each of the N sub-regions;
wherein the carbon emission change trend data comprises the first carbon emission change curve and the second carbon emission change curve of each of the N sub-regions.

In some embodiments, before step (5), the method further comprises:
(5a) setting the single sub-region as a current sub-region;
(5b) calculating an average change curvature of a first carbon emission change curve of the current sub-region as a first change trend index of the current sub-region;
(5c) acquiring K adjacent sub-regions of the current sub-region based on the city model;
(5d) calculating K first change trend indexes of the K adjacent sub-regions;
(5e) combined with a preset maximum deviation value, constructing a reasonable change interval of the current sub-region with the first change trend index of the current sub-region as a benchmark value;
(5f) extracting adjacent sub-regions with first change trend indexes within the reasonable change interval from the K adjacent sub-regions as correlated sub-regions;
(5g) extracting a sub-region with a largest first change trend index from the correlated sub-regions as a first sub-region, and extracting a sub-region with a smallest first change trend index from the correlated sub-regions as a second sub-region;
(5h) connecting the first sub-region, the current sub-region and the second sub-region in sequence to form a carbon emission tracking direction of the current sub-region; and
(5i) repeating steps (5a)-(5h) to obtain a carbon emission tracking direction of each of the N sub-regions.

In some embodiments, in step (5), the carbon prediction route is generated through steps of:
(5.1) according to the carbon emission tracking direction of each of the N sub-regions, analyzing an overall carbon tracking direction through the city model to generate the current carbon tracking route;
(5.2) acquiring the second carbon emission change curve of each of the N sub-regions, calculating, based on the second carbon emission change curve of each of the N sub-regions, second change trend indexes of the N sub-regions as N predicted carbon trend indexes respectively corresponding to the N sub-regions;
(5.3) according to the city model, constructing a path model based on the preset ant colony optimization algorithm; wherein in the path model, individual sub-regions are configured as movement path units;
(5.4) calculating N pheromone gain amounts based on the N predicted carbon trend indexes; wherein the N pheromone gain amounts are proportional to the N predicted carbon trend indexes;
(5.5) extracting sub-regions with predicted carbon trend indexes lower than a preset minimum index from the N sub-regions as starting sub-regions;
(5.6) in the path model, setting the starting sub-regions as ant starting points, setting the same preset number of ants at the ant starting points, and performing a first pheromone initialization on each of the movement path units;
(5.7) performing a second pheromone initialization on each of the movement path units based on the N pheromone gain amounts; and
(5.8) repeating steps (5.6)-(5.7) and updating a path pheromone of each of the movement path units in real time until an optimal path is formed; and marking the optimal path in the city model as the carbon prediction route.

In some embodiments, step (6) is performed through steps of:
(6.1) analyzing a carbon emission movement trend of each of the N sub-regions according to the current carbon tracking route, and acquiring a carbon emission impact level of each of the N sub-regions based on the carbon emission movement trend; wherein the higher the carbon emission impact level, the greater a carbon emission impact;
(6.2) performing a second analysis of the carbon pollution monitoring point number and the carbon pollution monitoring point distribution of each of the N sub-regions based on the carbon emission impact level of each of the N sub-regions, and dynamically correcting the carbon emission monitoring plan to generate the carbon emission monitoring correction plan for a next preset period; and
(6.3) performing pollution prediction analysis and regulation indicator generation on each of the industrial region, the agricultural region and the residential region based on the carbon prediction route and the city model, so as to obtain regulation indicator information corresponding to the industrial region, the agricultural region and the residential region.

In a second aspect, this application provides a system for implementing carbon tracking and analysis in a city, comprising:
a memory; and
a processor;
wherein the memory is configured to store a city carbon tracking and analysis program; and the city carbon tracking and analysis program is configured to be executed by the processor to implement steps of:
(1) acquiring basic information of a target city, and constructing a city model based on the basic information; wherein the city model is three-dimensional visual;
(2) dividing, based on regional information of the target city and the city model, the target city into a plurality of sub-regions;
(3) formulating a carbon emission monitoring plan based on regional properties of each of the plurality of sub-regions; performing carbon emission monitoring on each of the plurality of sub-regions based on the carbon emission monitoring plan; and acquiring carbon emission monitoring data of the target city within a current preset period;
(4) according to the carbon emission monitoring data, analyzing a carbon emission change of each of the plurality of sub-regions within the current preset period by means of linear regression, so as to obtain carbon emission change trend data of each of the plurality of sub-regions;
(5) performing carbon emission tracking based on the carbon emission change trend data; and generating a current carbon tracking route and a carbon prediction route by means of a preset ant colony optimization algorithm; and
(6) generating a monitoring correction plan based on the current carbon tracking route and the carbon prediction route.

In a third aspect, this application provides a non-transitory computer-readable storage medium, wherein a city carbon tracking and analysis program is stored on the non-transitory computer-readable storage medium; and the city carbon tracking and analysis program is configured to be executed by a processor to implement the above method.

Compared to the prior art, the present disclosure has the following beneficial effects.

This application provides a method, system and computer-readable storage medium for implementing carbon tracking and analysis in a city. Basic information of a target city is acquired. A three-dimensional visual city model is constructed based on the basic information. The target city is divided into a plurality of sub-regions. A carbon emission monitoring plan is formulated based on regional properties of each of the plurality of sub-regions. According to the acquired carbon emission monitoring data, a carbon emission change of each of the plurality of sub-regions within the current preset period is analyzed by means of linear regression to obtain carbon emission change trend data of each of the plurality of sub-regions. Carbon emission tracking is performed based on the carbon emission change trend data. A current carbon tracking route and a carbon prediction route are generated by means of a preset ant colony optimization algorithm. In this way, accurate carbon emission analysis and carbon emission prediction of a certain area in a city can be achieved, thus enabling the city to achieve accurate carbon tracking and generate a scientific carbon monitoring plan.

### BRIEF DESCRIPTION OF THE DRAWINGS

FIG. 1 is a flow chart of a method for carbon tracking and analysis in a city in accordance with an embodiment of the present disclosure;

FIG. 2 is a flow chart of constructing a city model in accordance with an embodiment of the present disclosure;

FIG. 3 is a schematic diagram of the city model in accordance with an embodiment of the present disclosure;

FIG. 4 is a flow chart of city sub-region division in accordance with an embodiment of the present disclosure; and

FIG. 5 is a block diagram of a system for implanting carbon tracking and analysis in a city in accordance with an embodiment of the present disclosure.

### DETAILED DESCRIPTION OF EMBODIMENTS

In order to understand the above objects, features and beneficial effects of the present disclosure more clearly, the technical solutions of the present disclosure will be further described below. It should be noted that, as long as there is no contradiction, the embodiments of the present disclosure and the features in the embodiments can be combined with each other.

Many specific details are set forth in the following description to facilitate the understanding of the present disclosure, but the present disclosure can also be implemented in other ways different from those described herein. Therefore, the embodiments described below are not intended to limit the scope of the present disclosure.

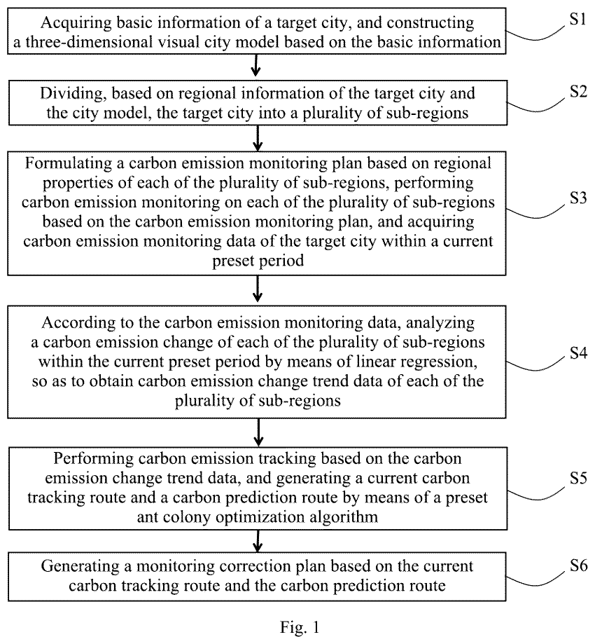

FIG. 1 is a flow chart of a method for carbon tracking and analysis in a city provided herein.

As shown in FIG. 1, a method for carbon tracking and analysis in a city is provided, which includes the following steps.

(S1) Basic information of a target city is acquired. A three-dimensional visual city model is constructed based on the basic information.

(S2) Based on regional information of the target city and the city model, the target city is divided into a plurality of sub-regions.

(S3) A carbon emission monitoring plan is formulated based on regional properties of each of the plurality of sub-regions. Carbon emission monitoring is performed on each of the plurality of sub-regions based on the carbon emission monitoring plan. Carbon emission monitoring data of the target city within a current preset period is acquired.

(S4) According to the carbon emission monitoring data, a carbon emission change of each of the plurality of sub-regions within the current preset period is analyzed by means of linear regression. Carbon emission change trend data of each of the plurality of sub-regions is acquired.

(S5) Carbon emission tracking is performed based on the carbon emission change trend data. A current carbon tracking route and a carbon prediction route is generated by means of a preset ant colony optimization algorithm.

(S6) A monitoring correction plan is generated based on the current carbon tracking route and the carbon prediction route.

It should be noted that the city model is a visual data carrier, and can be adopted to visualize analysis data such as subsequent carbon tracking routes.

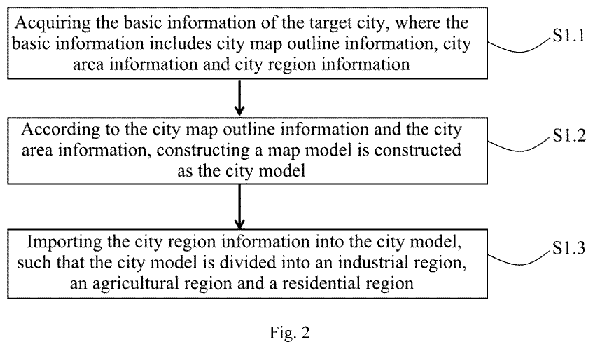

FIG. 2 is a flow chart of constructing the city model.

In an embodiment, the step (S1) is performed through the following steps.

(S1.1) The basic information of the target city is acquired. The basic information includes city map outline information, city area information and city region information. The city region information includes industrial region distribution information, agricultural region distribution information and residential region distribution information.

(S1.2) According to the city map outline information and the city area information, a map model is constructed as the city model.

(S1.3) The city region information is imported into the city model, such that the city model is divided into an industrial region, an agricultural region and a residential region.

It should be noted that the map model can visualize the industrial region distribution information, the agricultural region distribution information and the residential region distribution information, allowing a user to more intuitively understand urban carbon pollution.

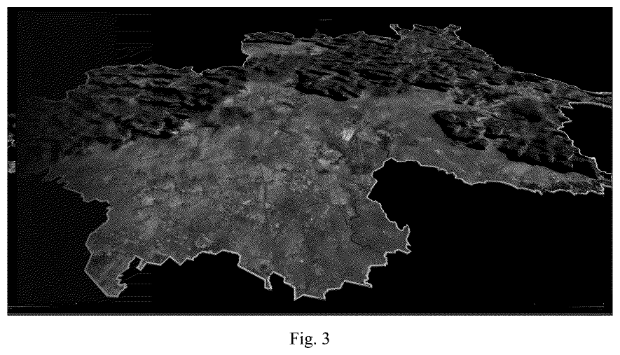

Specifically, the process of constructing the city model mainly includes data collection and preparation, data processing and modeling, scene optimization and integration, and interactive function development. The data collection and preparation involve the acquisition of geographic data and city region information. The geographic data can be obtained through satellite images, laser radar, drone aerial photography and the geographic information system (GIS). Based on the above process, a three-dimensional visual city model can be obtained, as shown in FIG. 3. Furthermore, the industrial region, the agricultural region and the residential region can be marked in the city model in the form of graphic masks, where the industrial region, the agricultural region and the residential region respectively correspond to graphic masks of different colors for distinction.

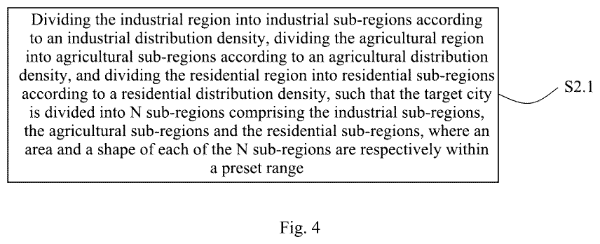

FIG. 4 is a flow chart of city sub-region division.

In an embodiment, step (S2) is performed through the following step.

(S2.1) The industrial region is divided into industrial sub-regions according to an industrial distribution density. The agricultural region is divided into agricultural sub-regions according to an agricultural distribution density. The residential region is divided into residential sub-regions according to a residential distribution density. In this way, the target city is divided into N sub-regions including the industrial sub-regions, the agricultural sub-regions and the residential sub-regions. An area and a shape of each of the N sub-regions are respectively within a preset range.

It should be noted that the preset range includes an area range and a shape limitation standard. The sub-region division enables precise monitoring and carbon tracking analysis of the target city.

In an embodiment, step (S3) is performed through the following steps.

(S3.1) Based on the city region information and the city model, distribution density analysis is performed on each of the industrial region, the agricultural region and the residential region to obtain industrial distribution density information, agricultural distribution density information and residential distribution density information.

(S3.2) Based on the industrial distribution density information, the agricultural distribution density information, the residential distribution density information and the city model, a first analysis of a carbon pollution monitoring point number and carbon pollution monitoring point distribution of each of the N sub-regions is performed to obtain the carbon emission monitoring plan.

(S3.3) The carbon emission monitoring is performed based on the carbon emission monitoring plan. The carbon emission monitoring data within the current preset period is acquired. The carbon emission monitoring data includes N sets of sub-region monitoring data.

It should be noted that the distribution density information includes the unit density distribution corresponding to industry, agriculture, and residence. Specifically, the industrial distribution density refers to the density distribution of factories in the industrial region, the agricultural distribution density refers to the density distribution of city planting areas, and the residential distribution density refers to the residential unit density and population density distribution. The carbon emission monitoring plan includes the number and distribution of carbon monitoring devices. One sub-region includes at least one carbon monitoring device. The specific number of the carbon monitoring devices is determined by the analysis of the industrial, agricultural and residential distribution density information of the city. For example, in a sub-region (set as an industrial sub-region) of a city, the greater the industrial distribution density, the more carbon monitoring devices there are. The carbon monitoring devices includes sensors, data collectors, global positioning system (GPS) modules, and wireless communication modules (such as Wireless Fidelity (Wi-Fi), Bluetooth, Long Range® (LoRa®), ZigBee® and cellular communications). The sensors are mainly configured to monitor pollutants such as carbon dioxide (CO₂), methane (CH₄), nitrous oxide (N₂O) and carbon monoxide (CO) in the air. The GPS modules are configured to record the geographical location information of the monitoring points. The carbon emission monitoring data is transmitted to the cloud through the wireless communication modules, thereby realizing information interaction with the city model.

In an embodiment, step (S4) is performed through the following steps.

(S4.1) A single sub-region among the N sub-regions is set as an analysis unit. A set of sub-region monitoring data corresponding to the single sub-region is acquired from the carbon emission monitoring data.

(S4.2) Carbon emission linear change analysis is performed on the set of sub-region monitoring data corresponding to the single sub-region to obtain a first carbon emission change curve of the single sub-region within the current preset period.

(S4.3) According to the first carbon emission change curve of the single sub-region, data prediction is performed by means of linear regression prediction, so as to obtain a next-period prediction curve as a second carbon emission change curve of the single sub-region.

(S4.4) Steps (S4.1)-(S4.3) are repeated to obtain a first carbon emission change curve and a second carbon emission change curve of each of the N sub-regions.

The carbon emission change trend data includes the first carbon emission change curve and the second carbon emission change curve of each of the N sub-regions.

It should be noted that a duration of the preset period is set by the user.

In an embodiment, before step (S5), the method further comprises the following steps.

(S5a) A single sub-region is set as a current sub-region.

(S5b) An average change curvature of a first carbon emission change curve of the current sub-region is calculated as a first change trend index of the current sub-region.

(S5c) K adjacent sub-regions of the current sub-region are acquired based on the city model.

(S5d) K first change trend indexes of the K adjacent sub-regions are calculated.

(S5e) Combined with a preset maximum deviation value, a reasonable change interval of the current sub-region is constructed with the first change trend index of the current sub-region as a benchmark value.

(S5f) Adjacent sub-regions with first change trend indexes within the reasonable change interval are extracted from the K adjacent sub-regions as correlated sub-regions.

(S5g) A sub-region with a largest first change trend index is extracted from the correlated sub-regions as a first sub-region. A sub-region with a smallest first change trend index is extracted from the correlated sub-regions as a second sub-region.

(S5h) The first sub-region, the current sub-region and the second sub-region are connected in sequence to form a carbon emission tracking direction of the current sub-region.

(S5i) Steps (S5a)-(S5h) are repeated to obtain a carbon emission tracking direction of each of the N sub-regions.

It should be noted that the adjacent sub-regions refer to the sub-regions adjacent to the current sub-region, that is, the surrounding sub-regions. The average change curvature is specifically the data obtained by selecting a preset number of curve points and calculating the curvatures of the curve points followed by averaging. The benchmark value is adopted as a middle value of the reasonable change interval. The positive and negative preset maximum deviation values of the benchmark value are adopted as the maximum and minimum values of the reasonable change interval. The first sub-region and the second sub-region are sub-regions exhibiting consistent change trends with the current sub-region, and have a certain difference in change trends. In the present disclosure, by analyzing the changing trends within the preset period and selecting the corresponding correlated sub-regions for connection, the carbon emission tracking route of the current sub-region can be accurately reflected. Moreover, by virtue of the calculation and analysis of the first change trend index, non-correlated sub-regions can be proposed, thus achieving accurate carbon emission tracking and analysis of the sub-regions.

In step (S5h), the obtained route direction has a start point and an end point. For example, when the first sub-region and the second sub-region are the upper and lower regions of the current sub-region respectively, the route direction is from top to bottom, corresponding to the route of carbon emissions.

In an embodiment, step (S5) is performed through the following steps.

(S5.1) According to the carbon emission tracking direction of each of the N sub-regions, an overall carbon tracking direction is analyzed through the city model to generate the current carbon tracking route.

(S5.2) The second carbon emission change curve of each of the N sub-regions is acquired. Based on the second carbon emission change curve of each of the N sub-regions, second change trend indexes of the N sub-regions are calculated as N predicted carbon trend indexes respectively corresponding to the N sub-regions.

(S5.3) According to the city model, a path model based on the preset ant colony optimization algorithm is constructed. In the path model, individual sub-regions are configured as movement path units.

(S5.4) N pheromone gain amounts are calculated based on the N predicted carbon trend indexes. The N pheromone gain amounts are proportional to the N predicted carbon trend indexes.

(S5.5) Sub-regions with predicted carbon trend indexes lower than a preset minimum index are extracted from the N sub-regions as starting sub-regions.

(S5.6) In the path model, the starting sub-regions are set as ant starting points. The same preset number of ants are set at the ant starting points. A first pheromone initialization is performed on each of the movement path units.

(S5.7) A second pheromone initialization is performed on each of the movement path units based on the N pheromone gain amounts.

(S5.8) Steps (5.6)-(5.7) are repeated, and a path pheromone of each of the movement path units is updated in real time until an optimal path is formed. The optimal path is marked in the city model as the carbon prediction route.

It should be noted that the pheromone gain amount is equal to the predicted carbon trend index multiplied by a preset correction coefficient. The second pheromone initialization refers to pheromone gain for each of the movement path units, and the gain amount is the pheromone gain amount. The N sub-regions are in one-to-one correspondence with the N predicted carbon trend indexes, that is, in one-to-one correspondence with the movement path units, that is also, in one-to-one correspondence with the N pheromone gain amounts. In the path model based on the preset ant colony optimization algorithm of the present disclosure, multiple starting points are set while no end point is set to simulate and predict movement patterns and trends of carbon emissions in different movement paths. Furthermore, the initial path selection of each sub-region is changed by gaining the pheromone, which is more consistent with the actual trend of carbon emission tracking paths in each region of the actual city, thus obtaining a highly accurate carbon prediction route. In addition, the pheromone gain is related to the predicted carbon trend index. In different periods, model parameters and corresponding initialization parameters can be adjusted in real time to adapt to different city carbon emission conditions.

In the present disclosure, the current carbon tracking route is obtained based on the current existing monitoring data, and is adopted to evaluate the real-time impact of current carbon emissions. The carbon prediction route is obtained based on the analysis of prediction data, and is adopted to evaluate the impact on future carbon emissions and provide data support for carbon pollution planning and management in corresponding cities.

The present disclosure facilitates improvement of carbon emission monitoring efficiency, reduction of monitoring cost of the target city and improvement of monitoring analysis accuracy, thereby achieving more accurate tracking and analysis of the city carbon trend, and further realizing scientific management of the city carbon emissions.

In an embodiment, step (6) is performed through the following steps.

(S6.1) A carbon emission movement trend of each of the N sub-regions is analyzed according to the current carbon tracking route. A carbon emission impact level of each of the N sub-regions is acquired based on the carbon emission movement trend. The higher the carbon emission impact level, the greater a carbon emission impact.

(S6.2) A second analysis of the carbon pollution monitoring point number and the carbon pollution monitoring point distribution of each of the N sub-regions is performed based on the carbon emission impact level of each of the N sub-regions. The carbon emission monitoring plan is dynamically corrected to generate the carbon emission monitoring correction plan for a next preset period.

(S6.3) Pollution prediction analysis and regulation indicator generation are performed on each of the industrial region, the agricultural region and the residential region based on the carbon prediction route and the city model, so as to obtain regulation indicator information corresponding to the industrial region, the agricultural region and the residential region.

It should be noted that the higher the carbon emission impact level, the greater the carbon emission impact, and the more serious the corresponding carbon pollution. The analysis of the carbon emission movement trend of each of the N sub-regions refers to analyzing which sub-regions are more prone to accumulate carbon pollutants and which sub-regions are less susceptible to the impacts of carbon emissions. Based on the carbon emission impact level, the carbon emission monitoring plan is dynamically revised, that is, the number and distribution of the carbon monitoring devices are adjusted. Specifically, for regions with high carbon emission impact level, the number of carbon monitoring devices is increased to increase the monitoring frequency; and for regions with low carbon emission impact level, some carbon monitoring devices are closed or removed accordingly to reduce the monitoring frequency. The optimization of the carbon monitoring device distribution can reduce monitoring costs and improve data representativeness, thereby achieving precise carbon tracking and scientific carbon monitoring in cities. The carbon prediction route can reflect the future carbon emission trend of the city to a certain extent. By virtue of such a trend, carbon emission regulation and carbon emission indicator generation can be carried out scientifically and reasonably in cities, thereby forming scientific, effective and practical regulation indicator information. Based on the complex situation of the city, city regulation indicators and regulation schemes can be obtained by combining the current carbon emission monitoring data analysis. The regulation indicator information enables the gradual reduction of city carbon emissions to be achieved scientifically and effectively, thereby carrying out effective regulation step by step.

The method for carbon tracking and analysis in the present disclosure integrates a multi-source data fusion algorithm and a machine learning model, and can calculate and analyze carbon emission data in real time, which provides a technical basis for data display and data analysis in the three-dimensional visual city model. The interactive function development is implemented for the city model. In combination with the data returned by the carbon monitoring devices, the first carbon emission change curve and the second carbon emission change curve of the sub-region can display by clicking on the sub-region in the city model. This achieves the precise positioning of carbon emission sources and the real-time updating of regional carbon monitoring data. In addition, the city model can display the distribution of carbon sink resources such as green space and forests, which is convenient for optimizing the management and layout of carbon sink resources. By virtue of the city model and the carbon emission monitoring data and carbon prediction data, it is easy to analyze the impact of urban form such as building density and industrial distribution on carbon emissions, which provides data support for the regulation of carbon emission indicators. In the process of implementing emission reduction strategies, the method can be cyclically executed to continuously evaluate the optimization effect and adjust the emission reduction strategy until the optimal regulation scheme is obtained.

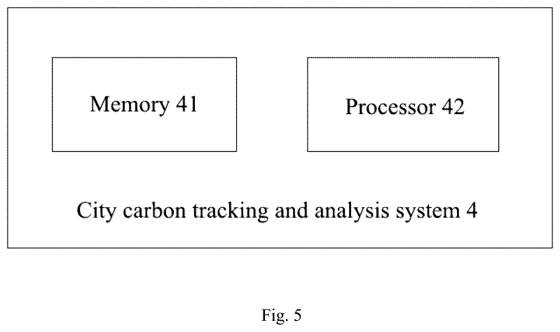

FIG. 5 is a block diagram of a system for carbon tracking and analysis in a city provided herein.

A system 4 for carbon tracking and analysis in a city is also provided, which includes a memory 41 and a processor 42. The memory is configured to store a city carbon tracking and analysis program. The city carbon tracking and analysis program is configured to be executed by the processor to implement the following steps.

(S1) Basic information of a target city is acquired. A three-dimensional visual city model is constructed based on the basic information.

(S2) Based on regional information of the target city and the city model, the target city is divided into a plurality of sub-regions.

(S3) A carbon emission monitoring plan is formulated based on regional properties of each of the plurality of sub-regions. Carbon emission monitoring is performed on each of the plurality of sub-regions based on the carbon emission monitoring plan. Carbon emission monitoring data of the target city within a current preset period is acquired.

(S4) According to the carbon emission monitoring data, a carbon emission change of each of the plurality of sub-regions within the current preset period is analyzed by means of linear regression. Carbon emission change trend data of each of the plurality of sub-regions is acquired.

(S5) Carbon emission tracking is performed based on the carbon emission change trend data. A current carbon tracking route and a carbon prediction route is generated by means of a preset ant colony optimization algorithm.

(S6) A monitoring correction plan is generated based on the current carbon tracking route and the carbon prediction route.

It should be noted that the city model is a visual data carrier, and can be adopted to visualize analysis data such as subsequent carbon tracking routes.

In an embodiment, the step (S1) is performed through the following steps.

(S1.1) The basic information of the target city is acquired. The basic information includes city map outline information, city area information and city region information. The city region information includes industrial region distribution information, agricultural region distribution information and residential region distribution information.

(S1.2) According to the city map outline information and the city area information, a map model is constructed as the city model.

(S1.3) The city region information is imported into the city model, such that the city model is divided into an industrial region, an agricultural region and a residential region.

It should be noted that the map model can visualize the industrial region distribution information, the agricultural region distribution information and the residential region distribution information, allowing a user to more intuitively understand urban carbon pollution.

In an embodiment, step (S2) is performed through the following step.

(S2.1) The industrial region is divided into industrial sub-regions according to an industrial distribution density. The agricultural region is divided into agricultural sub-regions according to an agricultural distribution density. The residential region is divided into residential sub-regions according to a residential distribution density. In this way, the target city is divided into N sub-regions including the industrial sub-regions, the agricultural sub-regions and the residential sub-regions. An area and a shape of each of the N sub-regions are respectively within a preset range.

It should be noted that the preset range includes an area range and a shape limitation standard. The sub-region division enables precise monitoring and carbon tracking analysis of the target city.

In an embodiment, step (S3) is performed through the following steps.

(S3.1) Based on the city region information and the city model, distribution density analysis is performed on each of the industrial region, the agricultural region and the residential region to obtain industrial distribution density information, agricultural distribution density information and residential distribution density information.

(S3.2) Based on the industrial distribution density information, the agricultural distribution density information, the residential distribution density information and the city model, a first analysis of a carbon pollution monitoring point number and carbon pollution monitoring point distribution of each of the N sub-regions is performed to obtain the carbon emission monitoring plan.

(S3.3) The carbon emission monitoring is performed based on the carbon emission monitoring plan. The carbon emission monitoring data within the current preset period is acquired. The carbon emission monitoring data includes N sets of sub-region monitoring data.

It should be noted that the distribution density information includes the unit density distribution corresponding to industry, agriculture, and residence. Specifically, the industrial distribution density refers to the density distribution of factories in the industrial region, the agricultural distribution density refers to the density distribution of city planting areas, and the residential distribution density refers to the residential unit density and population density distribution. The carbon emission monitoring plan includes the number and distribution of carbon monitoring devices. One sub-region includes at least one carbon monitoring device. The specific number of the carbon monitoring devices is determined by the analysis of the industrial, agricultural and residential distribution density information of the city. For example, in a sub-region (set as an industrial sub-region) of a city, the greater the industrial distribution density, the more carbon monitoring devices there are. The carbon monitoring devices includes sensors, data collectors, global positioning system (GPS) modules, and wireless communication modules (such as Wireless Fidelity (Wi-Fi), Bluetooth, Long Range® (LoRa®), ZigBee® and cellular communications). The sensors are mainly configured to monitor pollutants such as CO₂, CH₄, N₂O and CO in the air. The GPS modules are configured to record the geographical location information of the monitoring points. The carbon emission monitoring data is transmitted to the cloud through the wireless communication modules, thereby realizing information interaction with the city model.

In an embodiment, step (S4) is performed through the following steps.

(S4.1) A single sub-region among the N sub-regions is set as an analysis unit. A set of sub-region monitoring data corresponding to the single sub-region is acquired from the carbon emission monitoring data.

(S4.2) Carbon emission linear change analysis is performed on the set of sub-region monitoring data corresponding to the single sub-region to obtain a first carbon emission change curve of the single sub-region within the current preset period.

(S4.3) According to the first carbon emission change curve of the single sub-region, data prediction is performed by means of linear regression prediction, so as to obtain a next-period prediction curve as a second carbon emission change curve of the single sub-region.

(S4.4) Steps (S4.1)-(S4.3) are repeated to obtain a first carbon emission change curve and a second carbon emission change curve of each of the N sub-regions.

The carbon emission change trend data includes the first carbon emission change curve and the second carbon emission change curve of each of the N sub-regions. It should be noted that a duration of the preset period is set by the user.

In an embodiment, before step (S5), the method further comprises the following steps.

(S5a) A single sub-region is set as a current sub-region.

(S5b) An average change curvature of a first carbon emission change curve of the current sub-region is calculated as a first change trend index of the current sub-region.

(S5c) K adjacent sub-regions of the current sub-region are acquired based on the city model.

(S5d) K first change trend indexes of the K adjacent sub-regions are calculated.

(S5e) Combined with a preset maximum deviation value, a reasonable change interval of the current sub-region is constructed with the first change trend index of the current sub-region as a benchmark value.

(S5f) Adjacent sub-regions with first change trend indexes within the reasonable change interval are extracted from the K adjacent sub-regions as correlated sub-regions.

(S5g) A sub-region with a largest first change trend index is extracted from the correlated sub-regions as a first sub-region. A sub-region with a smallest first change trend index is extracted from the correlated sub-regions as a second sub-region.

(S5h) The first sub-region, the current sub-region and the second sub-region are connected in sequence to form a carbon emission tracking direction of the current sub-region.

(S5i) Steps (S5a)-(S5h) are repeated to obtain a carbon emission tracking direction of each of the N sub-regions.

It should be noted that the adjacent sub-regions refer to the sub-regions adjacent to the current sub-region, that is, the surrounding sub-regions. The average change curvature is specifically the data obtained by selecting a preset number of curve points and calculating the curvatures of the curve points followed by averaging. The benchmark value is adopted as a middle value of the reasonable change interval. The positive and negative preset maximum deviation values of the benchmark value are adopted as the maximum and minimum values of the reasonable change interval. The first sub-region and the second sub-region are sub-regions exhibiting consistent change trends with the current sub-region, and have a certain difference in change trends. In the present disclosure, by analyzing the changing trends within the preset period and selecting the corresponding correlated sub-regions for connection, the carbon emission tracking route of the current sub-region can be accurately reflected. Moreover, by virtue of the calculation and analysis of the first change trend index, non-correlated sub-regions can be proposed, thus achieving accurate carbon emission tracking and analysis of the sub-regions.

In step (S5h), the obtained route direction has a start point and an end point. For example, when the first sub-region and the second sub-region are the upper and lower regions of the current sub-region respectively, the route direction is from top to bottom, corresponding to the route of carbon emissions.

In an embodiment, step (S5) includes the following steps.

(S5.1) According to the carbon emission tracking direction of each of the N sub-regions, an overall carbon tracking direction is analyzed through the city model to generate the current carbon tracking route.

(S5.2) The second carbon emission change curve of each of the N sub-regions is acquired. Based on the second carbon emission change curve of each of the N sub-regions, second change trend indexes of the N sub-regions are calculated as N predicted carbon trend indexes respectively corresponding to the N sub-regions.

(S5.3) According to the city model, a path model based on the preset ant colony optimization algorithm is constructed. In the path model, individual sub-regions are configured as movement path units.

(S5.4) N pheromone gain amounts are calculated based on the N predicted carbon trend indexes. The N pheromone gain amounts are proportional to the N predicted carbon trend indexes.

(S5.5) Sub-regions with predicted carbon trend indexes lower than a preset minimum index are extracted from the N sub-regions as starting sub-regions.

(S5.6) In the path model, the starting sub-regions are set as ant starting points. The same preset number of ants are set at the ant starting points. A first pheromone initialization is performed on each of the movement path units.

(S5.7) A second pheromone initialization is performed on each of the movement path units based on the N pheromone gain amounts.

(S5.8) Steps (5.6)-(5.7) are repeated, and a path pheromone of each of the movement path units is updated in real time until an optimal path is formed. The optimal path is marked in the city model as the carbon prediction route.

It should be noted that the pheromone gain amount is equal to the predicted carbon trend index multiplied by a preset correction coefficient. The second pheromone initialization refers to pheromone gain for each of the movement path units, and the gain amount is the pheromone gain amount. The N sub-regions are in one-to-one correspondence with the N predicted carbon trend indexes, that is, in one-to-one correspondence with the movement path units, that is also, in one-to-one correspondence with the N pheromone gain amounts. In the path model based on the preset ant colony optimization algorithm of the present disclosure, multiple starting points are set while no end point is set to simulate and predict movement patterns and trends of carbon emissions in different movement paths. Furthermore, the initial path selection of each sub-region is changed by gaining the pheromone, which is more consistent with the actual trend of carbon emission tracking paths in each region of the actual city, thus obtaining a highly accurate carbon prediction route. In addition, the pheromone gain is related to the predicted carbon trend index. In different periods, model parameters and corresponding initialization parameters can be adjusted in real time to adapt to different city carbon emission conditions.

In the present disclosure, the current carbon tracking route is obtained based on the current existing monitoring data, and is adopted to evaluate the real-time impact of current carbon emissions. The carbon prediction route is obtained based on the analysis of prediction data, and is adopted to evaluate the impact on future carbon emissions and provide data support for carbon pollution planning and management in corresponding cities.

The present disclosure facilitates improvement of carbon emission monitoring efficiency, reduction of monitoring cost of the target city and improvement of monitoring analysis accuracy, thereby achieving more accurate tracking and analysis of the city carbon trend, and further realizing scientific management of the city carbon emissions.

In an embodiment, step (6) is performed through the following steps.

(S6.1) A carbon emission movement trend of each of the N sub-regions is analyzed according to the current carbon tracking route. A carbon emission impact level of each of the N sub-regions is acquired based on the carbon emission movement trend. The higher the carbon emission impact level, the greater a carbon emission impact.

(S6.2) A second analysis of the carbon pollution monitoring point number and the carbon pollution monitoring point distribution of each of the N sub-regions is performed based on the carbon emission impact level of each of the N sub-regions. The carbon emission monitoring plan is dynamically corrected to generate the carbon emission monitoring correction plan for a next preset period.

(S6.3) Pollution prediction analysis and regulation indicator generation are performed on each of the industrial region, the agricultural region and the residential region based on the carbon prediction route and the city model, so as to obtain regulation indicator information corresponding to the industrial region, the agricultural region and the residential region.

It should be noted that the higher the carbon emission impact level, the greater the carbon emission impact, and the more serious the corresponding carbon pollution. The analysis of the carbon emission movement trend of each of the N sub-regions refers to analyzing which sub-regions are more prone to accumulate carbon pollutants and which sub-regions are less susceptible to the impacts of carbon emissions. The carbon prediction route can reflect the future carbon emission trend of the city to a certain extent. By virtue of such a trend, carbon emission regulation and carbon emission indicator generation can be carried out scientifically and reasonably in cities, thereby forming scientific, effective and practical regulation indicator information. Based on the complex situation of the city, city regulation indicators and regulation schemes can be obtained by combining the current carbon emission monitoring data analysis. The regulation indicator information enables the gradual reduction of city carbon emissions to be achieved scientifically and effectively, thereby carrying out effective regulation step by step.

A non-transitory computer-readable storage medium is also provided. A city carbon tracking and analysis program is stored on the non-transitory computer-readable storage medium. The city carbon tracking and analysis program is configured to be executed by a processor to implement steps in the above method for carbon tracking and analysis. It should be noted that the non-transitory computer-readable storage medium can be used to store carbon emission monitoring data, visualization algorithm code and system configuration files, thereby supporting efficient operation of the platform and real-time data updating.

This application provides a method, system and computer-readable storage medium for implementing carbon tracking and analysis in a city. Basic information of a target city is acquired. A three-dimensional visual city model is constructed based on the basic information. The target city is divided into a plurality of sub-regions. A carbon emission monitoring plan is formulated based on regional properties of each of the plurality of sub-regions. According to the acquired carbon emission monitoring data, a carbon emission change of each of the plurality of sub-regions within the current preset period is analyzed by means of linear regression to obtain carbon emission change trend data of each of the plurality of sub-regions. Carbon emission tracking is performed based on the carbon emission change trend data. A current carbon tracking route and a carbon prediction route are generated by means of a preset ant colony optimization algorithm. In this way, accurate carbon emission analysis and carbon emission prediction of a certain area in a city can be achieved, thus enabling the city to achieve accurate carbon tracking and generate a scientific carbon monitoring plan.

It should be understood that the disclosed devices and methods provided in the above embodiments can be implemented in other ways. The embodiments described above are merely illustrative. For example, the division of the units is only a logical function division. In practical implementation, there may be other ways of division. For example, multiple units or components can be combined or integrated into another system, or some features can be omitted, or not implemented. In addition, the coupling, direct coupling or communication connection between the components shown or discussed herein can be realized through some interfaces, and the indirect coupling or communication connection of the devices or units, which can be in electrical, mechanical or other forms.

The units described as separate components may or may not be physically separated. The components displayed as units may or may not be physical units, which may be located in one place or distributed on multiple network units. Some or all of the units may be selected according to actual needs to achieve the purpose of the scheme in the embodiments of the present disclosure.

In addition, each functional unit described in the embodiments can be integrated into one processing unit, or each unit can be configured as an individual unit, or two or more units can be integrated into one unit. The above integrated unit can be implemented in the form of hardware or hardware plus software functional units.

Those skilled in the art should understand that all or part of the steps of the above method can be implemented by instructing relevant hardware through a computer program. The computer program can be stored in a computer-readable storage medium. When executed by the processor, the computer program can implement the steps of the above method. The computer-readable storage medium includes a mobile storage device, a read-only memory (ROM), a random-access memory (RAM), a magnetic disk, an optical disk and other medium that can store program codes.

Alternatively, if the above integrated unit of the present disclosure is implemented in the form of a software function module and sold or used as an independent product, it can also be stored in a computer-readable storage medium. Based on such understanding, the essential part of the technical solution of the embodiments, or a part thereof contributing to the prior art, can be embodied in a form of a software product. The computer software product is stored in a storage medium and includes a plurality of instructions to allow a computer device (which can be a personal computer, a server, or a network device, etc.) to execute all or part of the steps of the methods described in various embodiments of this application. The above storage medium includes a mobile storage device, an ROM, an RAM, a magnetic disk, an optical disk and other medium that can store program codes.

The embodiments described above are merely illustrative of the present disclosure, and are not intended to limit the patent scope of the present disclosure. Various modifications and replacements made by those skilled in the art without departing from the spirit of the disclosure shall fall within the scope of the present disclosure defined by the appended claims.

What is claimed is:

1. A method for carbon tracking and analysis in a city, comprising:
(1) acquiring basic information of a target city, and constructing a city model based on the basic information; wherein the city model is three-dimensional visual;
(2) dividing, based on regional information of the target city and the city model, the target city into a plurality of sub-regions;
(3) formulating a carbon emission monitoring plan based on regional properties of each of the plurality of sub-regions; performing carbon emission monitoring on each of the plurality of sub-regions based on the carbon emission monitoring plan; and acquiring carbon emission monitoring data of the target city within a current preset period;
(4) according to the carbon emission monitoring data, analyzing a carbon emission change of each of the plurality of sub-regions within the current preset period by means of linear regression, so as to obtain carbon emission change trend data of each of the plurality of sub-regions;
(5) performing carbon emission tracking based on the carbon emission change trend data; and generating a current carbon tracking route and a carbon prediction route by means of a preset ant colony optimization algorithm; and
(6) generating a monitoring correction plan based on the current carbon tracking route and the carbon prediction route.

2. The method of claim 1, wherein in step (1), the basic information comprises city map outline information, city area information and city region information; and the city region information comprises industrial region distribution information, agricultural region distribution information and residential region distribution information; and
the city model is constructed through steps of:
constructing the city model according to the city map outline information and the city area information; and
importing the city region information into the city model, such that the city model is divided into an industrial region, an agricultural region and a residential region.

3. The method of claim 2, wherein step (2) is performed through a step of:
dividing the industrial region into industrial sub-regions according to an industrial distribution density, dividing the agricultural region into agricultural sub-regions according to an agricultural distribution density, and dividing the residential region into residential sub-regions according to a residential distribution density, such that the target city is divided into N sub-regions comprising the industrial sub-regions, the agricultural sub-regions and the residential sub-regions;
wherein an area and a shape of each of the N sub-regions are respectively within a preset range.

4. The method of claim 3, wherein in step (3), the carbon emission monitoring plan is formulated through steps of:
based on the city region information and the city model, performing distribution density analysis on each of the industrial region, the agricultural region and the residential region to obtain industrial distribution density information, agricultural distribution density information and residential distribution density information; and
based on the industrial distribution density information, the agricultural distribution density information, the residential distribution density information and the city model, performing a first analysis of a carbon pollution monitoring point number and carbon pollution monitoring point distribution of each of the N sub-regions to obtain the carbon emission monitoring plan; and
the carbon emission monitoring data comprises N sets of sub-region monitoring data.

5. The method of claim 4, wherein step (4) is performed through steps of:
(4.1) setting a single sub-region among the N sub-regions as an analysis unit; acquiring a set of sub-region monitoring data corresponding to the single sub-region from the carbon emission monitoring data;
(4.2) performing carbon emission linear change analysis on the set of sub-region monitoring data corresponding to the single sub-region to obtain a first carbon emission change curve of the single sub-region within the current preset period;
(4.3) according to the first carbon emission change curve of the single sub-region, performing data prediction by means of linear regression prediction, so as to obtain a next-period prediction curve as a second carbon emission change curve of the single sub-region; and
(4.4) repeating steps (4.1)-(4.3) to obtain a first carbon emission change curve and a second carbon emission change curve of each of the N sub-regions;
wherein the carbon emission change trend data comprises the first carbon emission change curve and the second carbon emission change curve of each of the N sub-regions.

6. The method of claim 5, wherein before step (5), the method further comprises:
(5a) setting the single sub-region as a current sub-region;
(5b) calculating an average change curvature of a first carbon emission change curve of the current sub-region as a first change trend index of the current sub-region;
(5c) acquiring K adjacent sub-regions of the current sub-region based on the city model;
(5d) calculating K first change trend indexes of the K adjacent sub-regions;
(5e) combined with a preset maximum deviation value, constructing a reasonable change interval of the current sub-region with the first change trend index of the current sub-region as a benchmark value;
(5f) extracting adjacent sub-regions with first change trend indexes within the reasonable change interval from the K adjacent sub-regions as correlated sub-regions;
(5g) extracting a sub-region with a largest first change trend index from the correlated sub-regions as a first sub-region, and extracting a sub-region with a smallest first change trend index from the correlated sub-regions as a second sub-region;
(5h) connecting the first sub-region, the current sub-region and the second sub-region in sequence to form a carbon emission tracking direction of the current sub-region; and
(5i) repeating steps (5a)-(5h) to obtain a carbon emission tracking direction of each of the N sub-regions.

7. The method of claim 6, wherein step (5) comprises:
(5.1) according to the carbon emission tracking direction of each of the N sub-regions, analyzing an overall carbon tracking direction through the city model to generate the current carbon tracking route;
(5.2) acquiring the second carbon emission change curve of each of the N sub-regions, calculating, based on the second carbon emission change curve of each of the N sub-regions, second change trend indexes of the N sub-regions as N predicted carbon trend indexes respectively corresponding to the N sub-regions;
(5.3) according to the city model, constructing a path model based on the preset ant colony optimization algorithm; wherein in the path model, individual sub-regions are configured as movement path units;
(5.4) calculating N pheromone gain amounts based on the N predicted carbon trend indexes; wherein the N pheromone gain amounts are proportional to the N predicted carbon trend indexes;
(5.5) extracting sub-regions with predicted carbon trend indexes lower than a preset minimum index from the N sub-regions as starting sub-regions;
(5.6) in the path model, setting the starting sub-regions as ant starting points, setting the same preset number of ants at the ant starting points, and performing a first pheromone initialization on each of the movement path units;
(5.7) performing a second pheromone initialization on each of the movement path units based on the N pheromone gain amounts; and
(5.8) repeating steps (5.6)-(5.7) and updating a path pheromone of each of the movement path units in real time until an optimal path is formed; and marking the optimal path in the city model as the carbon prediction route.

8. The method of claim 7, wherein step (6) is performed through steps of:
(6.1) analyzing a carbon emission movement trend of each of the N sub-regions according to the current carbon tracking route, and acquiring a carbon emission impact level of each of the N sub-regions based on the carbon emission movement trend; wherein the higher the carbon emission impact level, the greater a carbon emission impact;
(6.2) performing a second analysis of the carbon pollution monitoring point number and the carbon pollution monitoring point distribution of each of the N sub-regions based on the carbon emission impact level of each of the N sub-regions, and dynamically correcting the carbon emission monitoring plan to generate the carbon emission monitoring correction plan for a next preset period; and
(6.3) performing pollution prediction analysis and regulation indicator generation on each of the industrial region, the agricultural region and the residential region based on the carbon prediction route and the city model, so as to obtain regulation indicator information corresponding to the industrial region, the agricultural region and the residential region.

9. A system for implementing carbon tracking and analysis in a city, comprising:
a memory; and
a processor;
wherein the memory is configured to store a city carbon tracking and analysis program; and the city carbon tracking and analysis program is configured to be executed by the processor to implement steps of:
(1) acquiring basic information of a target city, and constructing a city model based on the basic information; wherein the city model is three-dimensional visual;
(2) dividing, based on regional information of the target city and the city model, the target city into a plurality of sub-regions;
(3) formulating a carbon emission monitoring plan based on regional properties of each of the plurality of sub-regions; performing carbon emission monitoring on each of the plurality of sub-regions based on the carbon emission monitoring plan; and acquiring carbon emission monitoring data of the target city within a current preset period;
(4) according to the carbon emission monitoring data, analyzing a carbon emission change of each of the plurality of sub-regions within the current preset period by means of linear regression, so as to obtain carbon emission change trend data of each of the plurality of sub-regions;
(5) performing carbon emission tracking based on the carbon emission change trend data; and generating a current carbon tracking route and a carbon prediction route by means of a preset ant colony optimization algorithm; and
(6) generating a monitoring correction plan based on the current carbon tracking route and the carbon prediction route.

10. A non-transitory computer-readable storage medium, wherein a city carbon tracking and analysis program is stored on the non-transitory computer-readable storage medium; and the city carbon tracking and analysis program is configured to be executed by a processor to implement the method of claim 1.
